(19) United States
(12) Patent Application Publication
(10) Pub. No.: US 2008/0139396 A1
(43) Pub. Date: Jun. 12, 2008

(54) Method of Identifying Sugar Chain Structure and Apparatus For Analyzing the Same

(75) Inventors: Akihiko Kameyama, Ibaraki (JP); Hisashi Narimatsu, Ibaraki (JP); Norihiro Kikuchi, Tokyo (JP); Shuuichi Nakaya, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NATIONAL INSTITUTE OF ADVANCED INDUSTRIAL SCIENCE AND TECHNOLOGY, TOKYO (JP); MITSUI KNOWLEDGE INDUSTRY CO., LTD., TOKYO (JP); SHIMADZU CORPORATION, KYOTO-SHI (JP)

(21) Appl. No.: 10/593,157

(22) PCT Filed: Mar. 18, 2005
(86) PCT No.: PCT/JP2005/005630

§ 371 Date: Jul. 27, 2007

(30) Foreign Application Priority Data
Mar. 19, 2004 (JP) 2004-080611

(51) Int. Cl. C40B 20/08

(52) U.S. Cl. 506/6

(57) ABSTRACT

An object of the present invention is to provide a system for analyzing a sugar chain structure which can determine a complete primary structure of a sugar chain simply and rapidly with a small amount of sample. In a method of identifying an analysis-objective sugar chain structure using a mass spectrometer by comparing a measured MS3 fragment pattern with a reference MS3 fragment pattern stored in a database, where the measured MS3 fragment pattern is a fragmentation pattern of each MS2 fragment ion included in a measured MS2 fragment pattern obtained by subjecting the analysis-objective sugar chain to a fragmentation mass spectroscopy, the present invention is characterized in that, among a plurality of MS2 fragment ions included in a measured MS2 fragment pattern, a fragmentation mass spectroscopy is performed on only selected MS2 fragment ions, where each of the selected fragmentations has a plurality of reference MS3 fragment patterns stored in a database whose mutual similarity index is smaller than a predetermined value, wherein the plurality of reference MS3 fragment patterns have the same precursor ion mass to charge ratio as that of the selected MS2 fragment ion.

### TECHNICAL FIELD

The present invention relates to a system for analyzing a sugar chain structure using a mass spectrometer.

### BACKGROUND ART

By publication of draft sequence date of a human genome, a phase of research and development has transferred to analysis of a function and a structure of a protein and interaction analysis as a post-genome research. On the other hand, about a half of proteins in a living body undergo modification with a sugar chain after translation, and it is being clarified that, by undergoing of such the modification, its proper function is first exerted. Therefore, clarification of a function of a glycoprotein is an indispensable approach for realizing creation of a genome drug and regeneration medical practice. Therefore, as a next generation post-genome research, it is necessary to proceed research and development from a viewpoint of “glycoproteomics” aiming at comprehensively analyzing a sugar chain and a protein as a whole and clarifying its function and, in particular, development of new technique is demanded which can rapidly analyze a sugar chain whose function and structure are currently difficult to analyze.

A sugar chain is deeply involved in stability and localization of a protein, and plays an important role for manifestation of higher life function of a cell such as functioning as a recognizing molecule on a cell surface. However, a sugar chain has extremely high diversity due to the variety of the constituent sugars, the order of binding the constituent sugars, and differences in the binding format and difference in the anomer structure between constituent sugars. For example, among constituent sugars, glucose (Glc), galactose (Gal) and mannose (Man) are isomers having the same molecular weight. Although it is thought that the kinds of constituent sugars are not so many, most sugar chains are made by binding tens of constituent sugars, so that the number of the combination of binding is extremely large. In addition to that, there are many isomers due to branching structures, and isomer such as α and β anomer isomers, and some isomers are modified by sulfation or phosphorylation.

In addition to these diversities, the fact that the amount of sugar chains is extremely small makes their analyses further difficult, whereas, currently, no method of amplifying sugar chains has been developed yet.

Up to the present, various methods of analyzing the structure of a sugar chain, have been developed including one using a hydrolase and HPLC, and one utilizing lectin affinity chromatography, methylation analysis, mass spectroscopy and NMR (Okura and Kameyama “Current Situation and Future of Sugar Chain Structure Analysis ”, Bioindustry, CMC Publisher, January 2003, 18-24). However, complete structural information of a sugar chain is not obtained by any procedure alone, and it is necessary to perform analysis combining a plurality of procedures. For this reason, in order to analyze one sugar chain, troublesome operation and a long time are necessary, and high throughput analysis could not be performed.

From a viewpoint of high speed and easiness of operation, among the aforementioned various analysis methods, those using mass spectroscopy is expected to be the mainstream of sugar chain structural analysis in the future.

However, in a conventional mass spectroscopy by MS/MS (MS²), anomer isomers and structural isomers could not be distinguished.

Then, it is expected to obtain the information of a complicated structure of a sugar chain by repeating the steps of [(i) fragmentation]-[(ii) mass measurement and selection of fragmented ion]-[(iii) further fragmentation] of a sugar chain ion (MSⁿ) (Y Takegawa et al., “Structural assignment of isomeric 2-aminopyridin-derivatized oligosaccharides using MSn spectral matching”, Rapid Commun. Mass Spectrum, 2004; 18:385-391). However, since tens or even hundreds of fragmented ions are produced at every fragmentation, it is not practical to perform further fragmentation on all of these fragmented ions, and perform comparison (pattern matching) of all the fragment ions. Even when further fragmentations are limited to major fragmented ions, a large amount of sample is necessary if the fragmentations are performed by trial and error.

### DISCLOSURE OF THE INVENTION

An object to be solved by the present invention is to provide a system for analyzing a sugar chain that can determine the complete primary structure of a sugar chain simply and rapidly with a small amount of sample.

Through an intensive work to determine a sugar chain structure rapidly only by mass spectroscopy, the present inventors found out a method of obtaining rapidly and precisely the complete primary structural information of a sugar chain including the information of isomers and the information of the binding position of the monosaccharides by selecting an appropriate ion (or ions) among produced fragmented (fragment) ions and performing the next stage fragmentation on it (or them).

That is, the present invention which was done for solving the aforementioned object is a method of identifying an analysis-objective sugar chain structure using a mass spectrometer by comparing a measured MS3 fragment pattern with a reference MS3 fragment pattern stored in a database, where the measured MS3 fragment pattern is a fragmentation pattern of each MS2 fragment ion included in a measured MS2 fragment pattern obtained by subjecting the analysis-objective sugar chain to a fragmentation mass spectroscopy, characterized in that, among a plurality of MS2 fragment ions included in a measured MS2 fragment pattern, a fragmentation mass spectroscopy is performed on only selected MS2 fragment ions, where each of the selected MS2 fragment ions has a plurality of reference MS3 fragment patterns stored in a database whose mutual similarity index is the same as or smaller than a predetermined value, wherein the plurality of reference MS3 fragment patterns have the same precursor ion mass to charge ratio as that of the selected MS2 fragment ion.

As described above, since there are a variety of isomers in a sugar chain, it was thought that it is difficult to distinguish them by mass spectroscopy. However, it has become clear that, a difference in a fragment pattern is generated by repeating fragmentations. Currently, it is thought that, by measuring fragment patterns up to MS3, the structure of most sugar chains can be identified.

However, in order to obtain an MS3 fragment patterns, two stage fragmentations must be performed from an original sugar chain, whereby the number of MS3 fragment patterns obtained from one sugar chain is huge. The unorganized pattern matching of an MS3 fragment patterns obtained from an unknown sugar chain (which is referred to as “measured MS3 fragment pattern”) and an MS3 fragment patterns stored in the database (which is referred to as “reference MS3 fragment pattern”) is not only time-consuming, but also may obstruct correct pattern matching (or identification).

Then, in the present invention, as described above, among a plurality of MS2 fragment ions included in one measured MS2 fragment pattern, a fragmentation mass spectroscopy is performed on only selected MS2 fragment ions, where each of the selected MS2 fragment ions has a plurality of reference MS3 fragment patterns whose mutual similarity index is a predetermined value (first determined value) or smaller, wherein the plurality of reference MS3 fragment patterns have the same precursor ion mass to charge ratio as that of the selected MS2 fragment ion.

Herein, in the case where there are three or more such MS3 fragment patterns, the highest one of the similarity indexes of a combination of any two MS3 fragment patterns can be adopted as the similarity index mentioned above.

In the case where the mutual similarity index of reference MS3 fragment patterns stored in the database is high, and an MS3 fragment pattern is measured by performing MS3 analysis on an unknown sample, it is difficult to determine that the measured MS3 fragment pattern matches any one of them. According to the method of the present invention, determination can be performed more rapidly by performing fragmentation mass spectroscopy on an MS2 fragment ion having low mutual similarity index of MS3 fragment patterns first (or in the order of lower to higher similarity index), and performing comparison of MS3 fragment patterns (matching).

It is desirable to store the aforementioned mutual similarity index of MS3 fragment patterns in the database in advance by associating with the mass to charge ratio of the precursor ion. Thereby, more rapid pattern matching can be performed.

Regarding the aforementioned selected MS2 fragment ions, it is desirable to rank them by a predetermined standard. The ranking can be made based on the aforementioned mutual similarity index of MS3 fragment patterns. Alternatively, the number of reference MS3 fragment patterns stored in the database may be considered in making the ranking. Fragmentation mass spectroscopies are successively performed according to the ranking and, when the similarity index between the MS3 fragment pattern of an unknown sample obtained by analysis and a reference MS3 fragment pattern stored in the database is not smaller than a predetermined value (second predetermined value), analysis is completed there, and a sugar chain structure is identified based on the matched pattern.

It is desirable to adopt only such MS2 fragment ions that have the peak intensity in a measured MS2 fragment pattern not lower than a predetermined value for the object of such treatments.

Before the identification according to the aforementioned procedure, it is desirable to calculate a theoretical composition of the sugar chain from the measured MS2 fragment pattern (including the peak of the precursor ion) and, based on this, pre-select and restrict to ones to be compared with the measured MS2 fragment pattern and fragment ion among the MS2 fragment patterns and MS2 fragment ions stored in the database.

The aforementioned method shows a guideline for performing a further fragmentation mass spectroscopy on MS2 fragment ions. The method of the present invention can be similarly utilized in further fragmentation stages to determine which among fragment ions (MSn fragment ions) produced should be performed a further fragmentation mass spectroscopy first. As described before, it is thought that most sugar-chain structures can be identified by comparing MS3 fragment patterns. But it is sometimes necessary for some sugar chains which are complicated or have a subtle difference in the isomer structures, to perform an MS4 fragmentation or further ones. In this case, by using the method of the present invention as a guideline, its efficiency can be improved.

When a fragmentation mass spectroscopy is performed at each stage as described above, it is desirable to set the fragmentation energy of the precursor ion not less than a predetermined value, which is determined corresponding to the precursor ion. By setting the energy at approximately the value at which the precursor ion is almost completely fragmented, the reproducibility of a fragment pattern produced by a fragmentation becomes better, and the identification of a sugar chain structure becomes more reliable. It is desirable to store the predetermined fragmentation energy values in the database by associating with precursor ions.

Mass spectroscopy is expected to be a method which can rapidly perform structure analysis of complicated and various sugar chains. But, in order to perform a correct identification, it is necessary to repeat [(i) fragmentation]-[(ii) mass measurement and selection of fragmented ions]-[(iii) further fragmentation] of a sugar chain ion, and perform pattern matching up to at least MS3 fragment patterns. However, since tens or hundreds of fragmented ions are produced at every fragmentation, it is not practical to perform further fragmentation on all of these fragmented ions, and perform comparison (pattern matching). Even when further fragmentation is limited to major fragmented ions, a large amount of sample becomes necessary if the fragmentations are performed by trial and error.

The method of analyzing a sugar chain structure according to the present invention gives a useful guideline in performing a further fragmentation, and thereby, one can reach the objective identification rapidly. In addition, since needless analyses can be avoided, the consumption of a sample can be suppressed, and even a sample of small amount can be adequately identified.

### BRIEF DESCRIPTION OF THE DRAWINGS

FIG. 1 is a schematic construction view of an apparatus for carrying out the present invention.

FIG. 2 is a measured MS2 fragment pattern taken in one example of the present invention.

FIG. 3 is reference MS2 fragment patterns stored in a database which correspond to the aforementioned measured MS2 fragment pattern, and their structural model.

FIG. 4 is comparisons of MS3 fragment patterns having the same precursor ion of MS2 fragment ion.

FIG. 5 is a measured MS3 fragment pattern of an MS2 fragment ion at m/z=1280.

FIG. 6 is reference MS3 fragment patterns stored in the database which correspond to the aforementioned measured MS3 fragment pattern, and their structural model.

FIG. 7 is sugar chain structural formulas of two kinds of samples used for verifying the algorism for calculating a similarity index (dissimilarity index) of two fragment patterns (spectra).

FIG. 8 is a table of calculation results of the dissimilarity index of the samples.

FIG. 9 is sugar chain structural formulas of another two kinds of samples used for verifying the aforementioned algorism.

FIG. 10 is a table of calculation results of the dissimilarity index of the samples.

FIG. 11 is sugar chain structural formulas of still another two kinds of samples used for verifying the aforementioned algorism.

FIG. 12 is a table of calculation results of the dissimilarity index of the samples.

FIG. 13 is sugar chain structural formulas of still another three kinds of samples used for verifying the aforementioned algorism.

FIG. 14 is a table of calculation results of the dissimilarity index of the samples.

FIG. 15 is a flow chart showing the flow of an example of the method of the present invention.

### BEST MODE FOR CARRYING OUT THE INVENTION

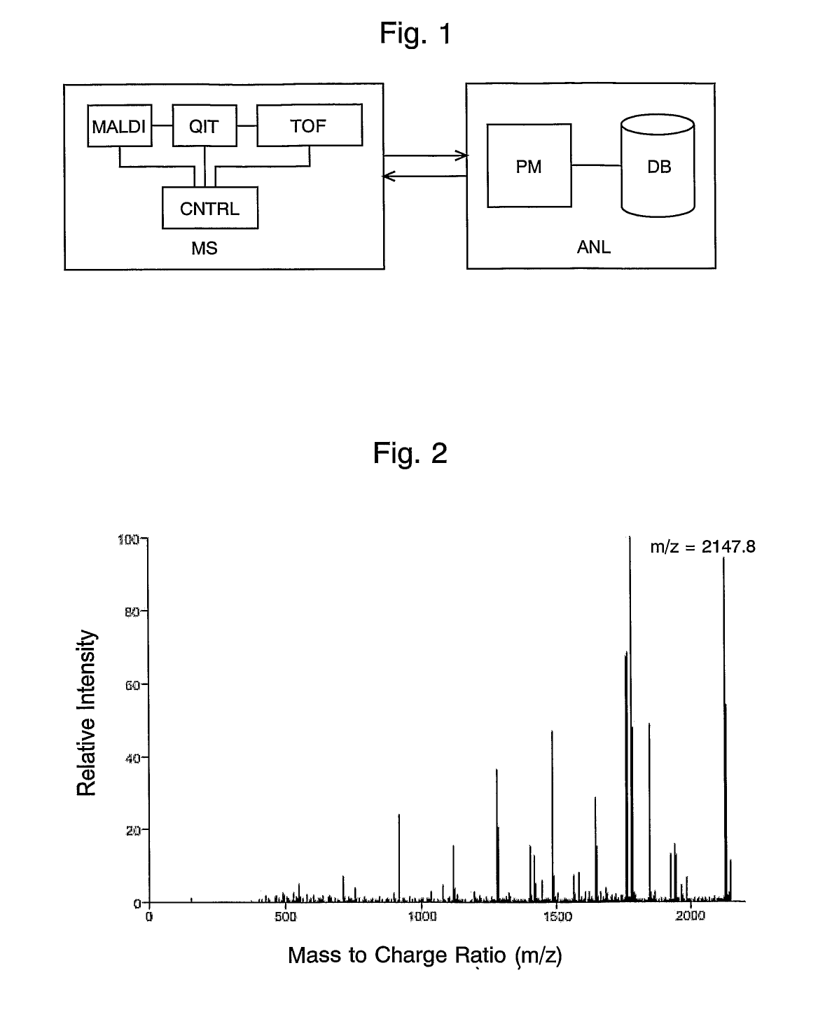

The present invention will be explained in detail below by way of one example. FIG. 1 shows a schematic construction of a sugar chain structure analyzer for carrying out the present invention. The analyzer includes a mass spectrometer MS part and an analyzing part ANL. The mass spectrometer MS is equipped with a matrix assisted laser desorption ionization (MALDI) ionizer, a quadrupole ion trap (QIT), and a time of flight (TOF) mass spectrometer, and the analyzing part ANL includes a database DB. Many mass spectroscopy patterns (fragment patterns) of sugar chain ions having known structures, as well as their primary and secondary (MS2 and MS3) fragmented ions are stored in the database. In addition, the analyzing part ANL is provided with a pattern matcher (PM) for comparing a fragment pattern (data) sent from a mass spectrometer MS with a fragment pattern (data) stored in the database DB, and calculating their similarity index. In the mass spectrometer MS part is provided a controlling part CNTL for controlling the whole analyzer.

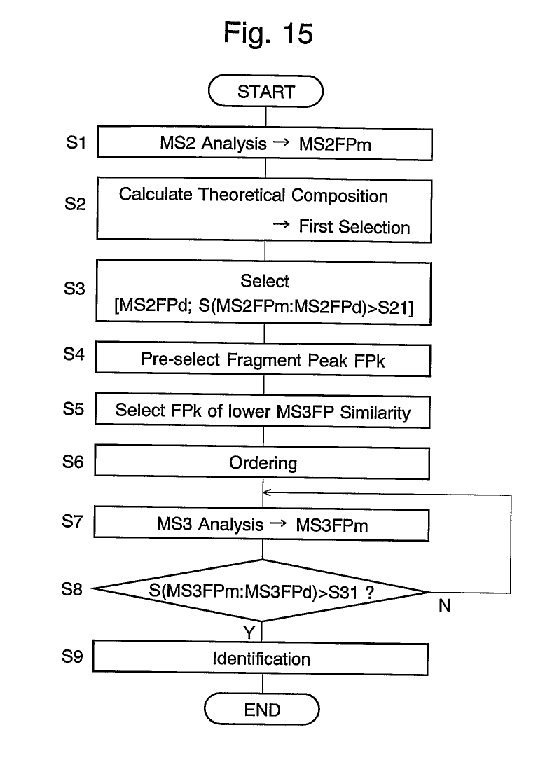

Using this analyzer, a method of performing an analysis of the structure of an unknown sugar chain will be explained employing the flow chart of FIG. 15. First, an unknown sugar chain to be identified is released from a biological sample containing glycoproteins or glycolipids using an appropriate nicking enzyme or utilizing an appropriate chemical cleaving reaction. The resulting sugar chain sample is labeled if necessary, mixed with a matrix agent, and is subjected to the mass spectrometer MS. In the mass spectrometer part MS, the sample is ionized with the MALDI, and a mass spectroscopy is performed with the TOF. Thereby, the mass to charge ratio ([mass m]/[charge z]) of the ion (precursor ion) of the sugar chain is measured. Further, by performing a fragmentation in the ion trap QIT, its fragment ions are produced, and the mass to charge ratio and intensity of each fragment ion are measured. Thereby, an MS/MS fragment pattern (measured MS2 fragment pattern, MS2FPm) is obtained (step S1). An example of the MS2 fragment pattern is shown in FIG. 2. In this example, the mass to charge ratio m/z of the precursor ion (ion of the unknown sugar chain sample) is 2147.8. Data of the MS2 fragment pattern are sent from the mass spectrometer MS to the analyzing part ANL.

In the analyzing part ANL, from data of the MS2 fragment pattern,

(1) the mass to charge ratio of the precursor ion,

(2) the mass to charge ratio of each fragment ion, and

(3) the intensity of each fragment ion

are taken out. The analyzing part ANL calculates theoretical compositions of the sugar chain based on these data, together with the information of the labeling agent, the nicking enzyme and the reagent which were used in preparing the sample (step S2). The information of the labeling agent and the like may be input on the mass spectrometer MS or on the analyzing part ANL by an operator.

In the case of an example of FIG. 2, from the mass to charge ratio 2147.8 of the precursor ion, a theoretical composition of the sugar chain is determined to be (Hex)5(HexNAc)6.

Then, in the analyzing part ANL, similarity index S between each of the MS2 fragment patterns of all sugar chain isomers (reference MS2 fragment pattern, MS2FPd) having the calculated theoretical composition and the MS2 fragment pattern (MS2FPm) sent from the mass spectrometer MS is calculated. The method of calculating the similarity index S (or the dissimilarity index D) of two fragment patterns will be explained in detail later. Then, only such reference MS2 fragment patterns having the similarity index S with the measured MS2 fragment pattern not smaller than a predetermined value S21 are pre-selected (step S3).

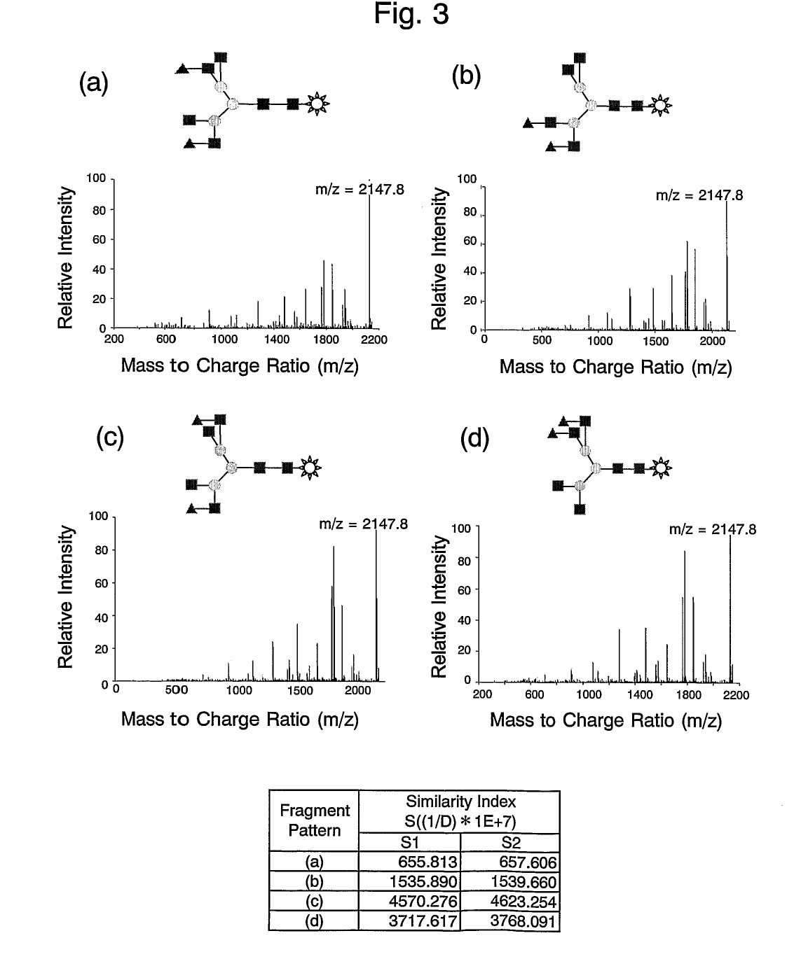

When the theoretical composition is (Hex)5(HexNAc)6, four MS2 fragment patterns of sugar chain isomers, as shown in FIG. 3, are stored in the database DB of the analyzing part ANL. A sugar chain structural model corresponding to each fragment pattern is shown on the pattern in FIG. 3. Only fragment patterns (c) and (d) have the similarity index S with the measured fragment pattern of FIG. 2 larger than the predetermined value S 21.

From thus pre-selected reference MS2 fragment patterns, a predetermined number of fragment peaks are selected in the order of higher to lower intensity (step S4). Here, in selecting the MS2 fragment peaks, the number of peaks may be predetermined, or peaks having a predetermined intensity level (relative to the maximum peak) or higher may be selected.

From the two reference MS2 fragment patterns of FIG. 3(c) and (d), the following six fragment peaks are selected.

m/z=2129

m/z=1848

m/z=1782

m/z=1645

m/z=1483

m/z=1280

Among thus selected fragment peaks, fragment ions (MS2 fragment ions) for which fragmentation mass spectroscopy should be then performed in the mass spectrometer MS are selected. Herein, the method of present invention is used.

MS3 fragment patterns stored in the database DB whose precursor ion is the fragment ion corresponding to the pre-selected fragment peak are read out (normally, a plurality of MS3 fragment patterns are stored relative to one precursor ion), and a similarity index (not a dissimilarity index D described later, but a similarity index which exhibits a higher value when two patterns are similar) S between them is calculated. And, only MS2 fragment ions having the similarity index of not larger than a predetermined value S22 are subjected to fragmentation mass spectroscopy in the mass spectrometer MS (step S5). At this time, these MS2 fragment ions are ranked in the order of smaller to larger similarity index (step S6).

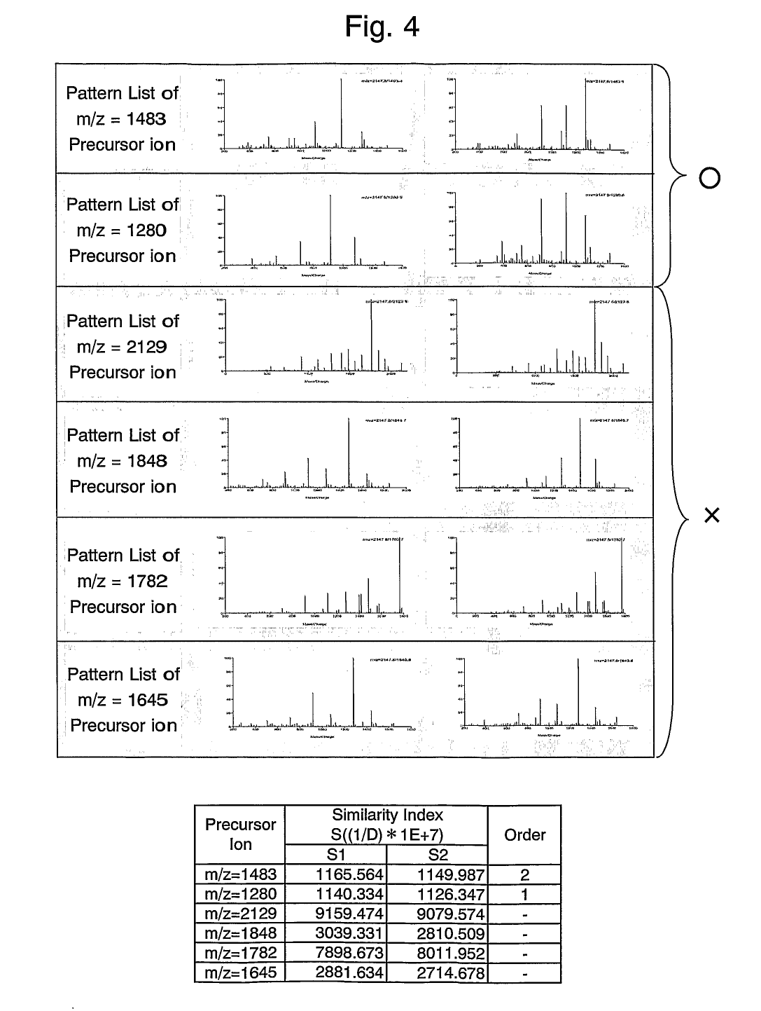

Regarding the aforementioned selected six fragment peaks, MS3 fragment patterns corresponding to respective peaks are shown in FIG. 4. Among them, two MS3 fragment patterns derived from the precursor ion of m/z=1483, and two MS3 fragment patterns derived from the precursor ion of m/z=1280 have lower mutual similarity index than that of MS3 fragment patterns derived from other precursor ions. When these reference MS3 fragment patterns stored in the database DB are compared (pattern matching) with the measured MS3 fragment pattern of an unknown sample, it is easier to determine that the measured MS3 fragment pattern matches one of the reference MS3 fragment patterns in the case where the similarity index of the two reference MS3 fragment patterns is small (i.e. the two patterns are remote) than the case where the two patterns are mutually similar.

FIG. 4 shows two MS3 fragment patterns for each precursor ion. It is possible that three or more MS3 fragment patterns are stored in the database DB for one precursor ion. In that case, a similarity index between arbitrary two MS3 fragment patterns may be used as the index. But, it is desirable to use the largest similarity index between any two MS3 fragment patterns, because, in this case, the similarity indexes between other MS3 fragment patterns are smaller than that. This enables secure measured/reference pattern matching.

In the case of FIG. 4, the similarity index between the MS3 fragment patterns is smaller in the case of m/z=1280. Thus, the MS2 fragment ion is adopted as primary, and the MS2 fragment ion of m/z=1483 is adopted as secondary.

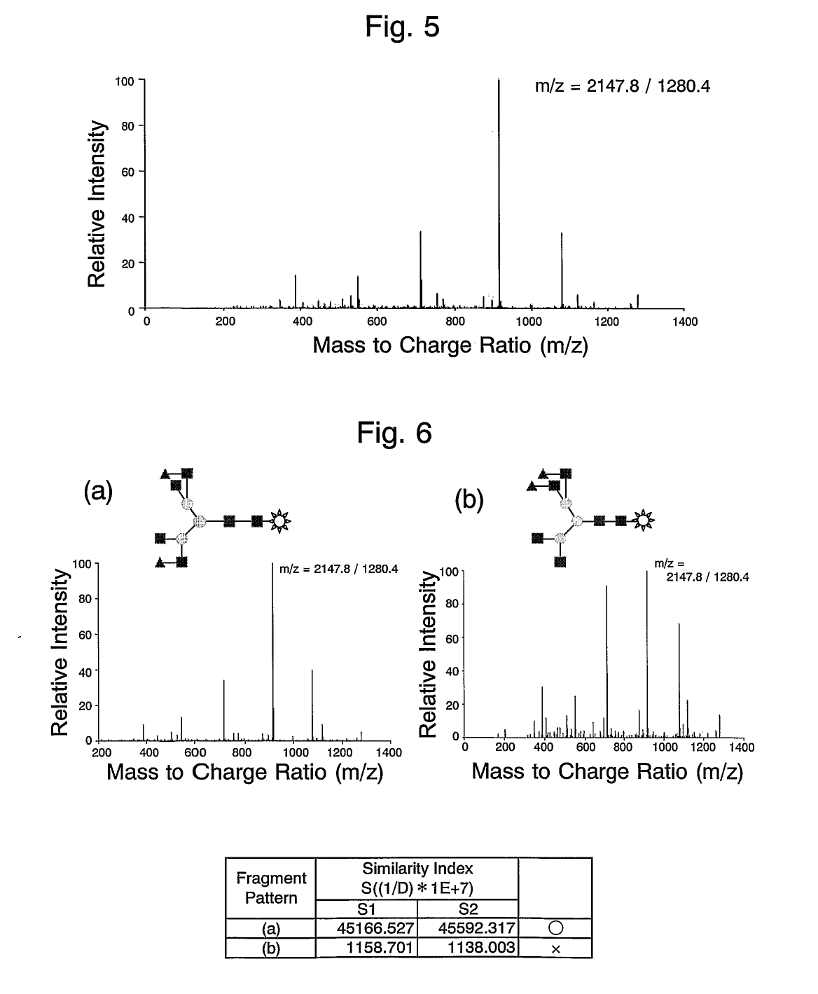

Based on the results of such selection and ranking, the analyzing part ANL sends data of the mass to charge ratio of the precursor ion which should be then subjected to fragmentation mass spectroscopy to the mass spectrometer MS. In the mass spectrometer MS, according to data sent from the analyzing part ANL, only the designated fragment ions (in the case of the above example, fragment ions of m/z=1280) among MS2 fragment ions that have been produced in the ion trap QIT are left in the ion trap QIT, and an MS3 mass spectroscopy is performed by fragmenting them with a predetermined energy (step S7). A measured MS3 fragment pattern of m/z=1280 (correctly m/z=1280.4) obtained by this is shown in FIG. 5.

Data of measured MS3 fragment pattern are sent from the mass spectrometer MS to the analyzing part ANL, and similarity indexes between the second stage two reference MS3 fragment patterns of FIG. 4 are calculated there, respectively, and are compared with a predetermined threshold S31 (step S8). In this case, as shown in FIG. 6, (a) has a higher similarity index with the measured MS3 fragment pattern.

Thus, the sugar chain of the analysis sample this time is determined to be (Hex)5(HexNAc)6 having the structure as shown at the upper part of FIG. 6(a) (step S9).

Then, the algorism for calculating the similarity index between a measured fragment pattern of an unknown sample and a reference fragment pattern stored in the database, which was used in the aforementioned identification procedure, is explained. In the following explanation of algorism, the aforementioned “fragment pattern” is referred to as “spectrum”.

(1) Regarding each of a measured spectrum and a reference spectrum, peaks in a certain range of m/z (mass to charge ratio) values are grouped into one (or merged). The peak having the highest intensity among these peaks is regarded as the peak after merging.

(2) Suppose the intensities of n peaks (P1, P2, . . . , Pn) of the measured spectrum after merging are xi (i=1−n), vector X of the measured spectrum is produced as

X=(x1, x2, . . . , xn).

(3) Regarding the reference spectrum, a peak of the reference spectrum corresponding to the peak Pi of the measured spectrum is determined, and vector Y of the reference spectrum is produced from the intensities of the peaks as

Y=(y1, y2, . . . , yn).

(4) Dissimilarity index D1 between the two spectra is obtained from the Euclidean distance between the two vectors X and Y as follows.

D1=Σ(i=1˜n)(Xi−yi)²

Since the value D1 calculated here is 0 (zero) when both spectra are completely the same, and the value D1 become larger as the difference in the two spectra becomes larger, the value D1 is expressed as a “dissimilarity index”. Naturally the value can be a measure of similarity between the two spectra. In order to express the similarity of two spectra that becomes larger as they become closer, the reciprocal of the dissimilarity index can be used.

(5) In the dissimilarity index D1 calculated as above, a known sugar chain structure (reference spectrum) having a peak which is not present in the spectrum of an unknown sample (measured spectrum) hits at a small dissimilarity index (large similarity index). Thus, a dissimilarity index D2 is calculated again by exchanging the vectors of the measured spectrum and the reference spectrum. That is, regarding reference spectra having the dissimilarity index D1 of not higher than a predetermined threshold, the aforementioned vector X is calculated from the reference spectrum, and the aforementioned vector Y is calculated from the measured spectrum, and the dissimilarity index D2 is obtained.

Effectiveness of the aforementioned method of calculating the dissimilarity index (similarity index) was verified by actual data. A sample used in the verification is a spectrum obtained by subjecting a sugar chain labeled with PA to mass spectroscopy. Letting the range of m/z value upon merging to be 0.8, and letting the range of m/z value in which peaks are regarded as the same to be 0.5, calculation was performed. The intensity value is taken by the % AREA value (the value of peak area in the predetermined range) of a peak list output by a mass spectrometer AXIMA/QIT (AXIMA is a registered trademark of Shimadzu Corporation).

(1) Comparison Between 0NA-00001a (100.1) and 0NA/00001b (100.2)

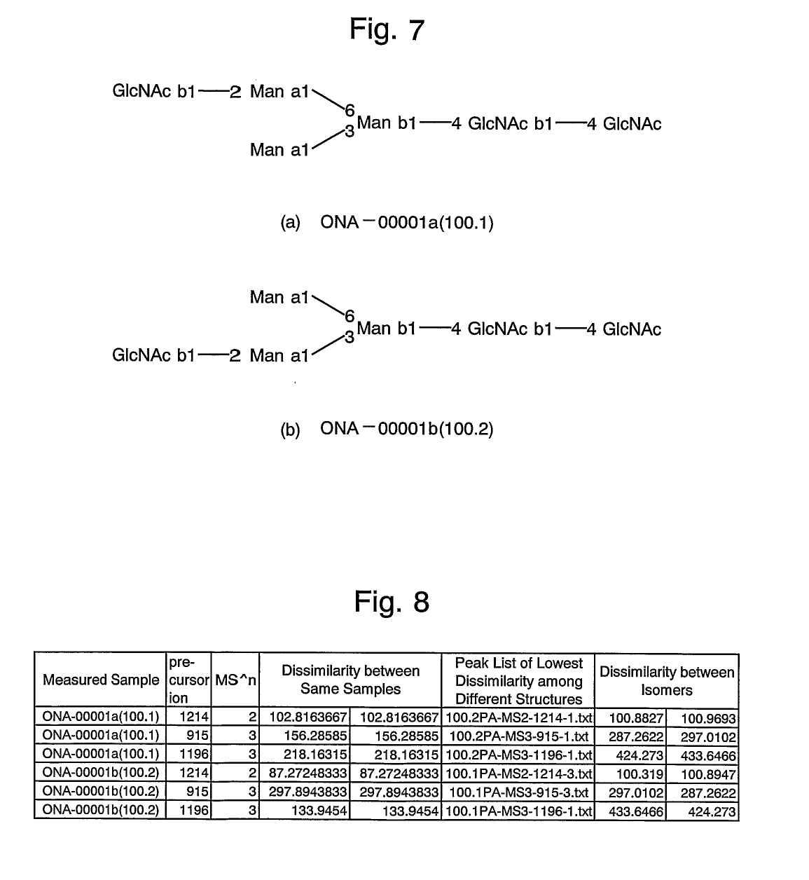

Their structural formulas are shown in FIG. 7(a) and (b). Regarding these two kinds of isomeric structures, the dissimilarity index between spectra of two samples having the same structure but collected from different experiments, and the dissimilarity index between spectra of two isomer samples were calculated. The results are shown in the table of FIG. 8.

The first row of the table of FIG. 8 is the results of calculation of a dissimilarity index of an MS2 spectrum of 0NA-00001a (100.1) (mass to charge ratio of the precursor ion is 1214). Data in the central two cells represent calculated values of average dissimilarity indexes obtained by subjecting the same sample to mass spectroscopy at two different times, and data in the right side two cells are values of their dissimilarity indexes with an MS2 spectrum of an isomer 0NA-00001b (100.2). In an MS2 spectrum, the dissimilarity index between the same samples and the dissimilarity index between isomer samples are not so different.

The second row of the table of FIG. 8 is the results of calculation of a dissimilarity index regarding a mass spectroscopy spectrum (MS3 spectrum) in which a fragment ion of 0NA-00001a (100.1) at m/z=915 is further fragmented. Similarly, data at central two cells are average dissimilarity indexes obtained by subjecting the same samples to mass spectroscopy at two different times, and data of right side two cells are their dissimilarity indexes with an MS3 spectrum of isomer 0NA-00001b (100.2) at the same m/z=915. When analyzed up to MS3 spectrum, the dissimilarity index between isomer samples is greater than the dissimilarity index between the same samples. The third row of the table of FIG. 8 is the results regarding the precursor ion at m/z=1196, showing the same results.

Fourth to sixth rows of the table of FIG. 8 are the results of similar calculation regarding 0NA-00001b (100.2). In the results of measurement of MS2 spectrum using the precursor ion at m/z=1214 and MS3 spectrum using the precursor ion at m/z=915, no difference is seen between the value of dissimilarity index between the same samples and the value of dissimilarity index between isomers, but in the results of MS3 spectrum using the precursor ion at m/z=1196, the dissimilarity index between the same samples is smaller than that between isomers.

(2) Comparison Between ONG-00001c (100.3) and ONG-00001d (100.4)

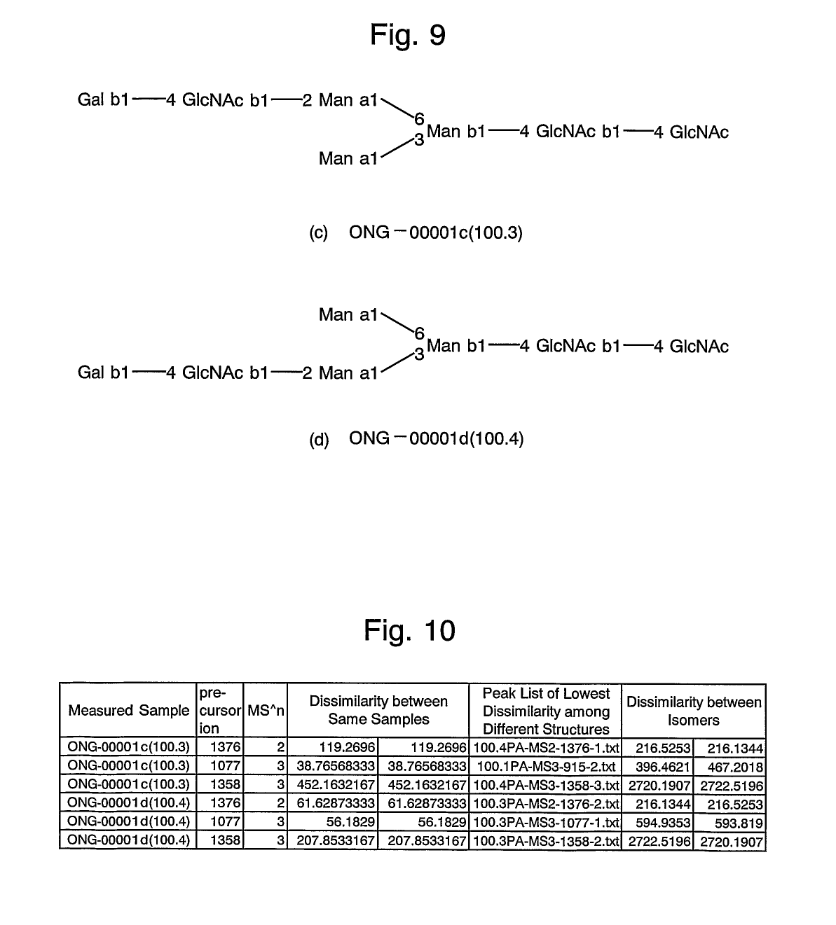

Structural formulas of both of them are shown in FIG. 9(c) and (d). Results of similar calculations of dissimilarity indexes are shown in the table of FIG. 10. In these samples, the dissimilarity index between the same samples is far smaller than that between isomer samples in any case.

(3) Comparison Between ONG-00001e (310.2) and ONG-00001f (310.3)

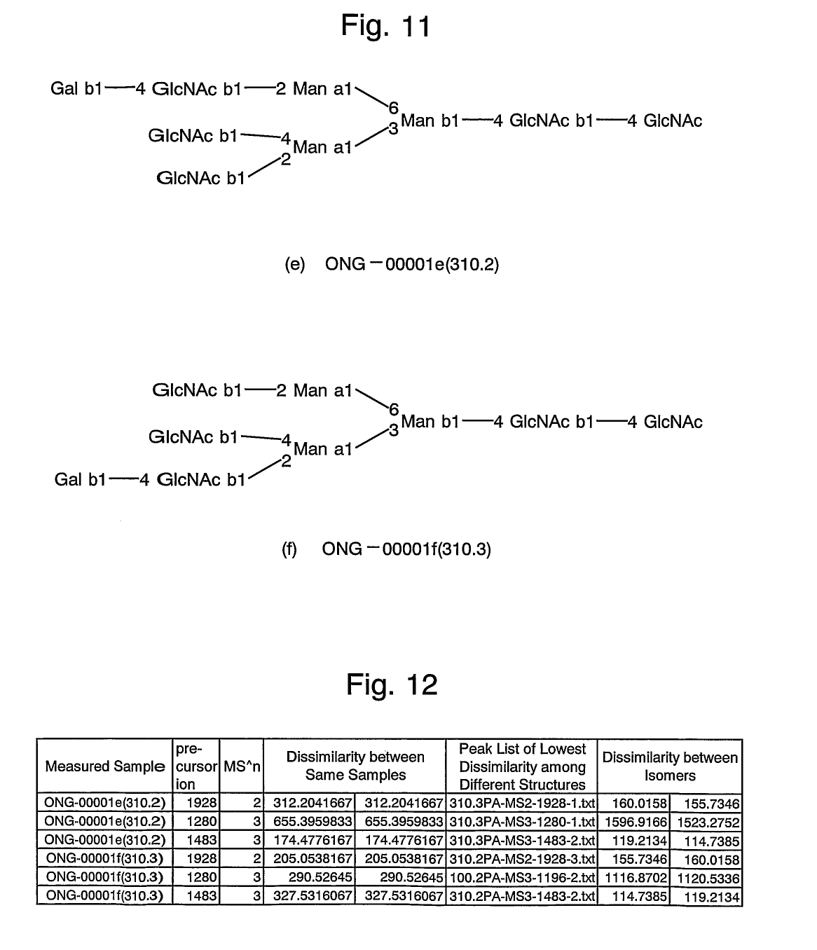

Structural formulas of both of them are shown in FIG. 11(e) and (f), and calculation results of dissimilarity indexes are shown in the table of FIG. 12. Regarding these samples, in the cases other than the case where the precursor ion of m/z=1280 is used, the dissimilarity index between the same samples is larger than that between isomer samples. This is because peaks of both samples appear slightly differently, and the difference is enhanced due to the merging procedure. In the MS3 spectrum using the precursor ion of m/z=1280, the dissimilarity index between the same samples is smaller than the dissimilarity index between isomer samples. Therefore, this can distinguish the two isomers.

(4) Comparison of Three of ONG-000020 (400.2), ONG-000021 (400.3) and ONG-000022 (400.5)

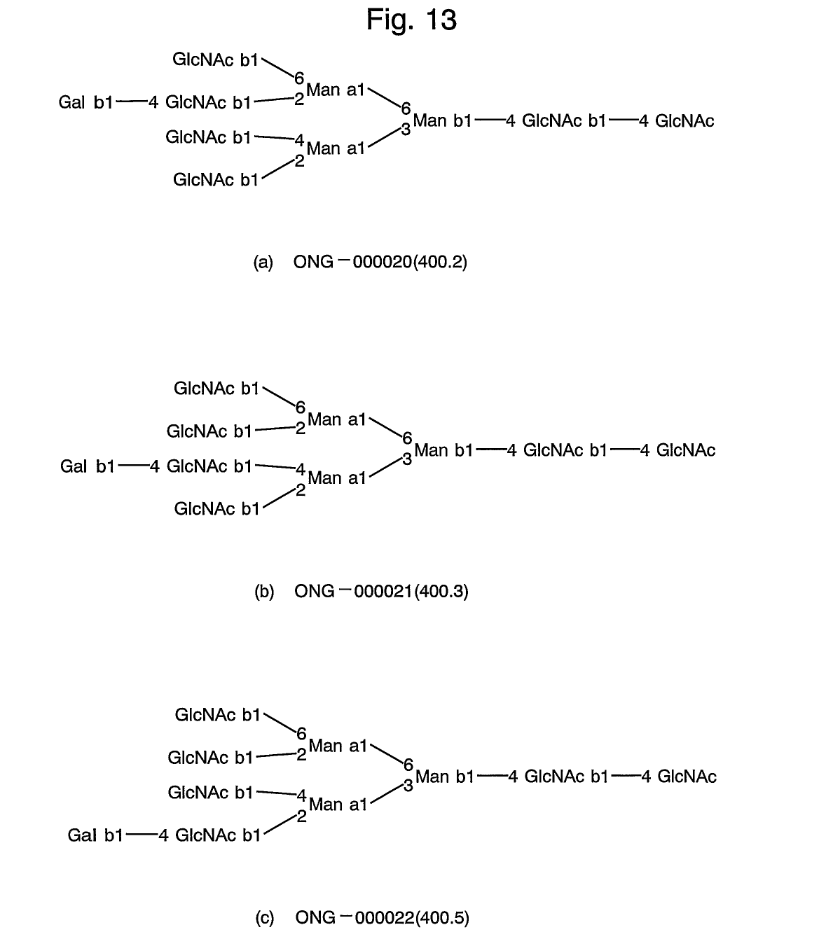

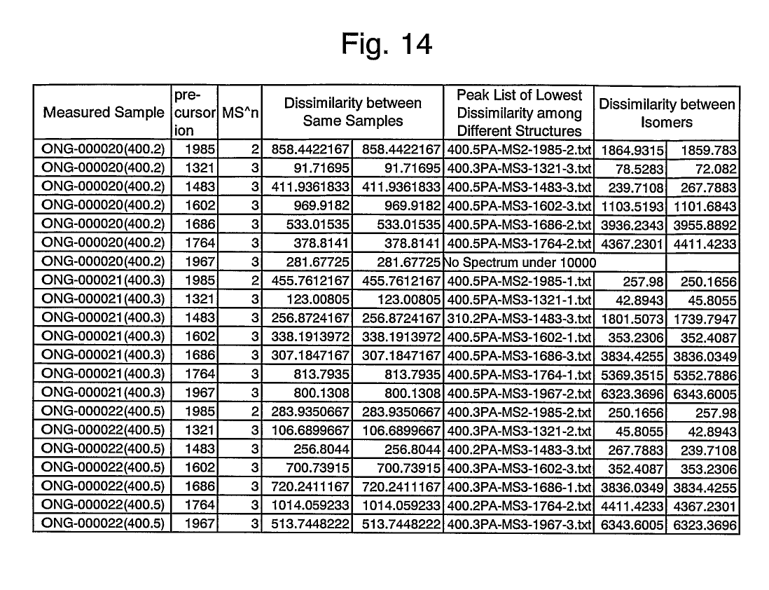

Respective structural formulas are as shown in FIG. 13. From the MS2 spectrum, these three kinds of isomers can not be distinguished. However, when MS3 is performed by selecting particular peaks, those isomers can be distinguished. In particular, in the case of MS3 spectrum using, as a peak, precursor ions of m/z=1686, 1764 and 1967, the structure having the smallest dissimilarity index (or the most similar sample) corresponds to the correct sugar chain structure.

From the aforementioned experimental results, first, it was confirmed that the aforementioned calculation method is effective for determining similarity index (dissimilarity index) between two spectra. In addition, it was made clear that, even when a difference in the structure between isomers is not reflected by a difference in the similarity index (dissimilarity index) of spectra at MS2 stage, the difference in the isomer structure can be distinguished by calculating the spectral similarity index (dissimilarity index) by performing fragmentation mass spectroscopy up to MS3.

1. In a method of identifying an analysis-objective sugar chain structure using a mass spectrometer by comparing a measured MS3 fragment pattern with a reference MS3 fragment pattern stored in a database, where the measured MS3 fragment pattern is a fragmentation pattern of each MS2 fragment ion included in a measured MS2 fragment pattern obtained by subjecting the analysis-objective sugar chain to a fragmentation mass spectroscopy,
the method of identifying a sugar structure characterized in that, among a plurality of MS2 fragment ions included in a measured MS2 fragment pattern, a fragmentation mass spectroscopy is performed on only selected MS2 fragment ions, where each of the selected MS2 fragment ions has a plurality of reference MS3 fragment patterns stored in a database whose mutual similarity index is the same as or smaller than a predetermined value, wherein the plurality of reference MS3 fragment patterns have the same precursor ion mass to charge ratio as that of the selected MS2 fragment ion.

2. The method of identifying a sugar chain structure according to claim 1, wherein reference MS4 fragment patterns or MSn reference fragment patterns from further fragmentation are further stored in the database, identification of a sugar chain structure is performed by comparing them with a measured MS4 fragment pattern or an MSn measured fragment pattern from further fragmentation, and, in the same manner as described above, only measured MSn fragment ions having mutual similarity index between a plurality of reference MSn+1 fragment patterns of not higher than a predetermined value are subjected to a further fragmentation mass spectroscopy.

3. In a method of identifying an analysis-objective sugar chain structure using a mass spectrometer by comparing a measured MS3 fragment pattern with a reference MS3 fragment pattern stored in a database, where the measured MS3 fragment pattern is a fragmentation pattern of each MS2 fragment ion included in a measured MS2 fragment pattern obtained by subjecting the analysis-objective sugar chain to a fragmentation mass spectroscopy,
the method of identifying a sugar structure characterized in that, among a plurality of MS2 fragment ions included in a measured MS2 fragment pattern, fragmentation mass spectroscopies are performed in the order of smaller to larger mutual similarity index of the a plurality of MS3 fragment patterns stored in a database, wherein the plurality of reference MS3 fragment patterns have the same precursor ion mass to charge ratio as that of the selected MS2 fragment ion.

4. The method of identifying a sugar chain structure according to claim 3, wherein reference MS4 fragment patterns or MSn reference fragment patterns from further fragmentation are further stored in the database, identification of a sugar chain structure is performed by comparing with a measured MS4 fragment pattern or an MSn measured fragment pattern from further fragmentation, and, in the same manner as described above, only measured MS4 fragment ions having mutual similarity index between a plurality of reference MSn+1 fragment patterns of not higher than a predetermined value are subjected to a further fragmentation mass spectroscopy.

5. The method of identifying a sugar chain structure according to claim 1, wherein the mutual similarity index between the aforementioned reference MSn+1 fragment patterns is stored in the database by associating with a mass to charge ratio of the precursor ion.

6. The method of identifying a sugar chain structure according to claim 1, wherein only MSn fragment ions having a peak intensity in a measured MSn fragment pattern of not lower than a predetermined value are subjected to the identification method.

7. The method of identifying a sugar chain structure according to claim 1, wherein a theoretical composition of a sugar chain is calculated from a measured MSn fragment pattern and, based on this, among reference MSn+1 fragment patterns stored in the database, patterns to be compared are restricted in advance.

8. The method of identifying a sugar chain structure according to claim 1, wherein the fragmentation energy of the fragmentation mass spectroscopy is set to be not smaller than a predetermined value depending on the precursor ion.

9. The method of identifying a sugar chain structure according to claim 8, wherein the predetermined value of fragmentation energy is stored in the database.

10. The method of identifying a sugar chain structure according to claim 1, wherein the similarity index between two fragment patterns is determined by the following method:
a) in a first fragment pattern, peaks having a mass to charge ratio in a predetermined range are grouped together and, among those peaks, the peak having the highest intensity is adopted as the peak representing the range.
b) in a second fragment pattern, a representative peak is selected by the same ranging as that described above.
c) letting the Euclidean distance between two vectors composed of the elements of intensities of the representative peaks in respective ranges of both fragment patterns as a dissimilarity index, and similarity index is determined based on the dissimilarity index.

11. The method of identifying a sugar chain structure according to claim 10, wherein regarding a second fragment pattern having the dissimilarity index of not higher than a predetermined value relative to a first fragment pattern, the aforementioned procedure is repeated by exchanging first and second patterns to calculate a second dissimilarity index, and the similarity index is determined based on the second dissimilarity index.

12. A mass spectrometer for analyzing a sugar chain, which comprises:
a mass spectroscopy part equipped with a means for holding and fragmenting an ion,
a database part in which MSn fragment patterns of known sugar chains are stored, and
a data processing part for controlling the mass spectrometer based on the method as defined in any one of claims 1 to 11 and identifying the analysis-objective sugar chain.

13. A program for carrying out the method as defined in any one of claims 1 to 11.
